(19) United States
(12) Patent Application Publication
(10) Pub. No.: US 2009/0051730 A1
(43) Pub. Date: Feb. 26, 2009

(54) Discharge Surface Cleaning Device for Liquid Discharge Head

(75) Inventor: Masaji Nakatani, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/886,921

(22) PCT Filed: Mar. 27, 2006
(86) PCT No.: PCT/JP2006/306129

§ 371 Date: Sep. 21, 2007

(30) Foreign Application Priority Data
Mar. 28, 2005 (JP) 2005-090839

(51) Int. Cl. B41J 2/165

(52) U.S. Cl. 347/33

(57) ABSTRACT

A discharge surface cleaning device for a liquid discharge head includes a wiping member, a washing liquid discharge device, and one or more absorbing members. The wiping member cleans the discharge surface by moving relative to the discharge surface while in contact with the discharge surface. The washing liquid discharge device applies a washing liquid directly to the wiping member. The absorbing member absorbs ink, and the washing liquid, on the wiping member.

### TECHNICAL FIELD

The invention relates to a discharge surface cleaning device for a liquid discharge head that discharges ink (including liquids used in the manufacture of semiconductors, liquid crystal panels, etc., as well as ink used for image formation), for cleaning the discharge surface by use of a wiping member.

### BACKGROUND OF THE INVENTION

As a liquid discharge device provided with a liquid discharge head, such as a printer, repeatedly discharges ink onto objects, a discharge surface thereof becomes contaminated with ink splashes and the like. The contaminant on the discharge surface sometimes prevents normal discharge of ink. This causes the discharged ink not to be applied to intended points. Thus, the discharge surface should be cleaned at regular intervals.

A commonly known method of cleaning the discharge surface is by moving a wiping member while the wiping member is kept in contact with the discharge member. As the wiping member repeatedly cleans the discharge surface, however, ink removed from the discharge surface adheres to and contaminates the wiping member. When contaminated, the wiping member has a decreased ability to clean the discharge surface. Thus, the wiping member should be cleaned.

There have been four major known techniques of cleaning wiping members.

In the first technique, ink on a wiping member is absorbed by an absorbing member being brought into contact with the wiping member.

In the second technique, ink on a wiping member is removed by an absorbing member arranged along a direction of rectilinear reciprocating motion of the wiping member for sliding contact with the wiping member after the wiping member cleans the discharge surface (see Patent Literature 1).

In the third technique, a wiping member is washed by use of a washing liquid (see Patent Literature 2). For example, the wiping member is formed rotatably. When being washed, the wiping member is rotated, in a direction opposite to the one in which the wiping member is rotated when cleaning the discharge surface, to be immersed into a washing liquid in a washing tank.

In the fourth technique, a member with ink absorbability is used as a wiping member, and ink on the discharge surface is absorbed by the wiping member being brought into contact with the discharge surface.

Patent Literature 1: Japanese Patent No. 3253713

Patent Literature 2: Japanese Laid-open Patent Application No. 2004-243663

### DISCLOSURE OF THE INVENTION

### Technical Problem

In the first technique, however, the wiping member is merely brought into contact with the absorbing member. Thus, the first technique has disadvantages that ink is absorbed in the absorbing member with a poor efficiency and that ink is removed less effectively from the wiping member.

It is supposed that the second technique is superior to the first technique in effectiveness of removal of ink from the wiping member. In the second technique, however, the friction between the wiping member and the absorbing member causes wear of the wiping member. The wear of the wiping member causes some of the ink on the discharge surface to be left unremoved and results in a reduction in effectiveness of ink removal from the discharge surface.

The second technique has another disadvantage that ink absorbed and remaining in the absorbing member results in a reduction in absorbability of the absorbing member. Further, the second technique is disadvantageous in that, when the absorbed ink becomes dry, components, such as pigments, of the ink remain and accumulate in the absorbing member as the wiping member is repeatedly cleaned and that the accumulated components prevent the wiping member from being cleaned properly.

The third technique necessitates not only the provision of the washing tank but also replacement of the washing liquid in the washing tank. Thus, this technique is disadvantageous in that the device has a complicated configuration.

The fourth technique uses, as the wiping member, a member that can absorb ink. The wiping member thus expands to some degree with the ink absorbed, causing a change in contact pressure at which the wiping member is pressed against the discharge surface. The fourth technique has a disadvantage that the change in contact pressure results in a change in effectiveness of ink removal from the discharge surface. This technique has another disadvantage that, when a material having low expansivity is used as the wiping member, the wiping member damages the discharge surface when brought into contact with the discharge surface since materials having low expansivity generally have high hardness.

An object of the invention is to provide a discharge surface cleaning device for a liquid discharge, capable of improving effectiveness of removal of ink from the discharge surface by enhancing effect of prevention of contamination of a wiping member.

### TECHNICAL SOLUTION

To solve the foregoing problems, the discharge surface cleaning device for a liquid discharge head according to aspects of the invention is configured as described below.

(1) The discharge surface cleaning device for a liquid discharge head according to an aspect of the invention includes a wiping member, a washing liquid discharge device, and one or more absorbing members.

The wiping member cleans a discharge surface of the liquid discharge head that discharges ink, by moving relative to the discharge surface while in contact with the discharge surface.

The washing liquid discharge device applies a washing liquid directly to the wiping member.

The absorbing members absorb ink, and the washing liquid, on the wiping member.

In this configuration, the discharge surface of the liquid discharge head is cleaned by the wiping member. The direct application of the washing liquid to the wiping member allows, after most of the ink on the wiping member is washed away, the ink and the washing liquid on the wiping member to be absorbed in the absorbing members.

(2) The wiping member reciprocates rectilinearly parallel to and relative to the discharge surface.

The washing liquid discharge device applies the washing liquid to the wiping member on a path of the rectilinear reciprocating motion of the wiping member.

In this configuration, the discharge surface, the wiping member, and a position at which the washing liquid is applied to the wiping member are located on a single path of the rectilinear reciprocating motion. Thus, a moving mechanism for moving the wiping member and the discharge surface relative to each other can be also used as a moving mechanism for applying the washing liquid to the wiping member.

(3) The wiping member reciprocates rectilinearly parallel to and relative to the discharge surface.

The absorbing members are positioned at two respective ends of the path of the rectilinear reciprocating motion of the wiping member.

In this configuration, the absorbing members are brought into contact with both of two sides of the wiping member, so that ink is removed from the two sides of the wiping member.

(4) The discharge surface cleaning device for a liquid discharge head further includes a suction device for sucking ink, and the washing liquid, absorbed in the absorbing members.

In this configuration, sucking by the suction device when the wiping member is brought into contact with the absorbing members enhances effectiveness of removal of ink and the washing liquid from the wiping member. Also, the suction of the ink and the washing liquid from the absorbing members prevents accumulation of the ink and the washing liquid in the absorbing members even when the ink and the washing liquid are repeatedly absorbed, and therefore, a reduction in absorbability of the absorbing members.

(5) The discharge surface cleaning device for a liquid discharge head according to another aspect of the invention includes a wiping member, one or more absorbing members, a washing liquid discharge device, and a suction device.

The wiping member cleans a discharge surface of the liquid discharge head that discharges ink, by moving relative to the discharge surface while in contact with the discharge surface.

The absorbing members absorb a liquid including ink on the wiping member when brought into contact with the wiping member.

The washing liquid discharge device applies a washing liquid to the wiping member through the absorbing members.

The suction device sucks the liquid including ink absorbed in the absorbing members.

In this configuration, ink on the discharge surface is removed by the wiping member. After cleaning the discharge surface, the wiping member is brought into contact with the absorbing members, and the washing liquid is applied to the wiping member through the absorbing members. The ink removed from the discharge surface and attached to the wiping member is washed away with the washing liquid and absorbed in the absorbing members. The ink and the washing liquid absorbed in the absorbing members are sucked by the suction device.

(6) The washing liquid discharge device applies the washing liquid to the wiping member in a state in which there is a gap for the liquid including ink on the wiping member to drop through formed between the wiping member and each of the absorbing members.

In this configuration, the ink on the wiping member drops through the gap between the wiping member and each of the absorbing members, together with the washing liquid applied to the wiping member.

(7) Each of the absorbing members includes a flexible porous body.

In this configuration, the absorbing members have flexibility and thus does not cause damage to the wiping member when brought into contact with the wiping member.

(8) The wiping member has a top end for contact with the discharge surface and a bottom end fixed at a predetermined position.

Each of the absorbing members has an inclined or curved surface that is to come into contact with the top end of the wiping member, before the bottom end, when the absorbing members are brought into contact with the wiping member.

In this configuration, the absorbing members are pressed against the top end at a higher contact pressure than against the bottom end.

(9) The discharge surface cleaning device as described above further includes a timer and a control section.

The timer measures time elapsed since the washing liquid discharge device has previously applied the washing liquid to the wiping member.

The control section causes the washing liquid discharge device to apply the washing liquid to the wiping member when the control section judges based on measurement result of the timer that a predetermined time has elapsed since the washing liquid discharge device has previously applied the washing liquid to the wiping member.

In this configuration, the washing liquid is applied to the wiping member, and the washing liquid applied to the wiping member is absorbed in the absorbing members, when a predetermined time has elapsed since the washing liquid has been previously applied to the wiping member, irrespective of whether an operation to remove ink from the discharge surface is performed. Setting a predetermined time to a time in which the ink does not become solidified prevents solidification of the ink on the wiping member and the ink absorbed in the absorbing members.

(10) Each time the wiping member cleans the discharge surface, the washing liquid discharge device applies the washing liquid to the wiping member, and the absorbing members absorb ink, and the washing liquid, on the wiping member.

In this configuration, ink is removed from the wiping member each time the ink is attached to the wiping member.

### ADVANTAGEOUS EFFECTS

The invention provides the following advantageous effects.

(1) Washing away ink on the wiping member by applying the washing liquid directly to the wiping member enhances effect of prevention of contamination of the wiping member. This improves effectiveness of removal of ink from the discharge surface of the liquid discharge head. This improves precision of ink discharge of the liquid discharge head.

(2) The moving mechanism for moving the wiping member and the discharge surface relative to each other can be also used as the moving mechanism for applying the washing liquid to the wiping member. This results in downsizing and low manufacturing cost of the device.

(3) Ink can be removed from the two sides of the wiping member. This further enhances the effect of prevention of contamination of the wiping member.

(4) The provision of the suction device for sucking ink and the washing liquid absorbed in the absorbing members allows ink and the washing liquid to be effectively removed from the wiping member by being sucked by the suction device when the wiping member is brought into contact with the absorbing members. This also prevents a reduction in absorbability of the absorbing members, and thus enhances the effect of prevention of contamination of the wiping member. Further, this results in a reduced frequency of replacement of the absorbing members.

(5) The application of the washing liquid to the wiping member enhances effectiveness of removal of ink from the wiping member. Also, the suction of the ink and the washing liquid absorbed in the absorbing members by the suction device prevents accumulation of the ink and the washing liquid in the absorbing members even when the ink and the washing liquid are repeatedly absorbed from the wiping member, and therefore, a reduction in absorbability of the absorbing members. This enhances the effect of prevention of contamination of the wiping member, and therefore, improves the effectiveness of removal of ink from the discharge surface of the liquid discharge head, as well as the precision of ink discharge of the liquid discharge head. Further, this results in a reduced frequency of replacement of the absorbing members.

(6) The ink on the wiping member drops through the gap between the wiping member and each of the absorbing members, together with the washing liquid applied to the wiping member. This further enhances the effectiveness of removal of ink from the wiping member.

(7) The flexible porous resin used as the absorbing members allows the ink to be removed from the wiping member without damaging the wiping member when brought into contact with the wiping member.

(8) The absorbing members are pressed against the top end at a higher contact pressure than against the bottom end. This enhances effectiveness of removal of ink from the top end that has attached thereto a larger amount of ink removed from the discharge surface.

(9) The application of the washing liquid to the wiping member at regular intervals prevents solidification of ink on the wiping member and ink absorbed in the absorbing members. Thus, the prevention of solidification of the ink on the wiping member results in prevention of damage to the discharge surface of the liquid discharge surface. Also, the prevention of solidification of the ink absorbed in the absorbing members results in prevention of a reduction in absorbability of the absorbing members, and thus further enhances the effect of prevention of contamination of the wiping member.

(10) Removing ink from the wiping member each time the ink is attached to the wiping member further enhances the effect of prevention of contamination of the wiping member.

### BRIEF DESCRIPTION OF THE DRAWINGS

FIG. 1 is a front view illustrating a schematic configuration of a discharge surface cleaning device for a liquid discharge head according to an embodiment of the invention.

FIG. 2 is a plan view illustrating a schematic configuration of the discharge surface cleaning device.

FIG. 3 is a block diagram illustrating a schematic configuration of the discharge surface cleaning device.

FIG. 4 is an explanatory drawing illustrating a discharge surface cleaning process performed by the discharge surface cleaning device: FIG. 4A illustrates how component elements are positioned before the discharge surface cleaning process is started; and FIG. 4B illustrates states in which the component elements are while the discharge surface cleaning process is being performed.

FIG. 5 is an explanatory drawing illustrating a wiping member washing process performed by the discharge surface cleaning device: FIG. 5A illustrates a state in which washing liquid discharge ports are when discharging a washing liquid to the wiping member; and FIG. 5B illustrates a state in which absorbing members are when absorbing ink and the like on one side of the wiping member.

FIG. 6 is an explanatory drawing illustrating the wiping member washing process performed by the discharge surface cleaning device.

FIG. 7 is a flowchart illustrating part of steps performed by a control section.

FIG. 8 is a front view illustrating a schematic configuration of a discharge surface cleaning device for a liquid discharge head according to another embodiment of the invention.

FIG. 9 is an explanatory drawing illustrating a discharge surface cleaning process performed by the discharge surface cleaning device: FIG. 9A illustrates how component elements are positioned before the discharge surface cleaning process is started; and FIG. 9B illustrates states in which the component elements are while the discharge surface cleaning process is being performed.

FIG. 10 is an explanatory drawing illustrating a wiping member pre-washing process performed by the discharge surface cleaning device.

FIG. 11 is an explanatory drawing illustrating the wiping member washing process performed by the discharge surface cleaning device: FIG. 11A illustrates a state in which absorbing members are when absorbing ink and the like on one side of the wiping member; and FIG. 11B illustrates a state in which the absorbing members are when absorbing ink and the like on the other side of the wiping member.

FIG. 12 is an enlarged view illustrating a configuration of part of a discharge surface cleaning device for a liquid discharge head according to still another embodiment of the invention.

FIG. 13 is an enlarged view illustrating a configuration of part of a discharge surface cleaning device for a liquid discharge head according to yet another embodiment of the invention.

### DESCRIPTION OF THE REFERENCE NUMERALS

1, 1A, 1B, 1C discharge surface cleaning device
2 liquid receiving tray
3 wiping member moving mechanism
4 liquid discharge head
5, 12A, 12B washing liquid discharge ports (washing liquid discharge devices)
6A, 6B, 26A, 26B, 36A, 36B absorbing members
7A, 7B suction ports (suction devices)
9 discharge surface
16 wiping member
50 control section

### THE BEST MODE FOR CARRYING OUT THE INVENTION

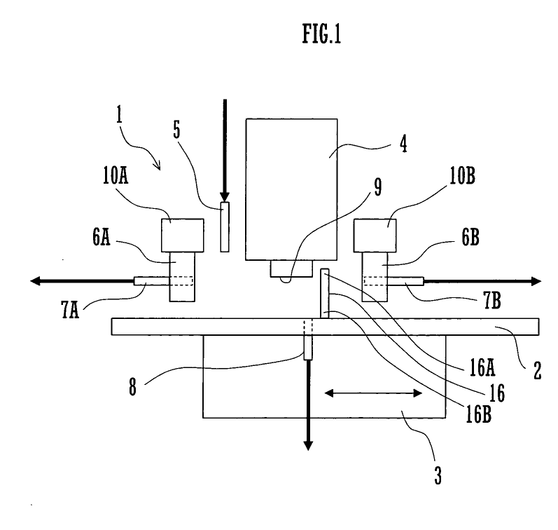

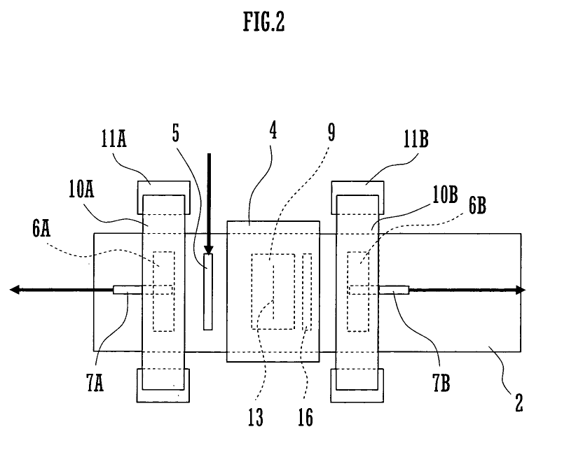

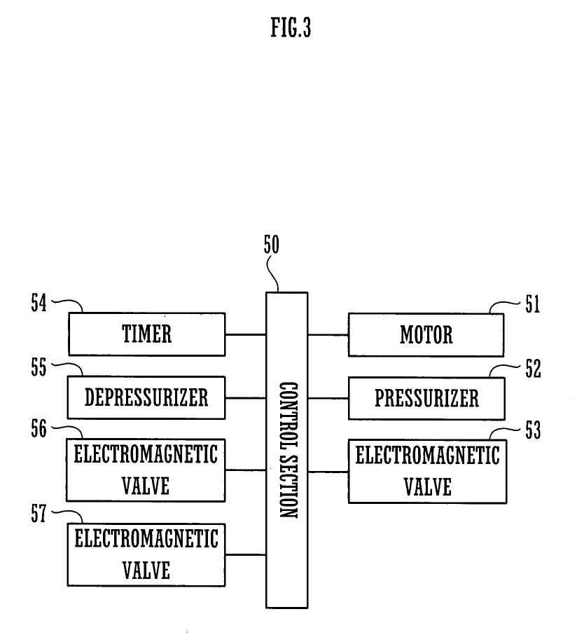

With reference to the accompanying drawings, embodiments of the invention will be described below. FIG. 1 is a front view illustrating a schematic configuration of a discharge surface cleaning device 1 for a liquid discharge head 4 according to an embodiment of the invention. FIG. 2 is a plan view illustrating a schematic configuration of the discharge surface cleaning device 1. FIG. 3 is a block diagram illustrating a schematic configuration of the discharge surface cleaning device 1. It is to be noted that the term “ink” as used herein includes liquids used in the manufacture of semiconductors, liquid crystal panels, etc., as well as ink used for image formation.

The discharge surface cleaning device 1 includes a wiping member 16, a liquid receiving tray 2, a wiping member moving mechanism 3, a washing liquid application port (washing liquid discharge device) 5, absorbing members 6A, 6B, suction ports (suction devices) 7A, 7B, a suction port 8, and a control section 50.

On an end thereof, the liquid discharge head 4 has a discharge surface 9 for discharging ink. When a discharge surface cleaning process in which the wiping member 16 cleans the discharge surface 9 is to be performed, the liquid discharge head 4 is moved to a predetermined discharge surface cleaning position by a not-shown head moving mechanism, as shown in FIGS. 1 and 2.

The wiping member 16 has a bottom end 16B supported on the liquid receiving tray 2. The wiping member 16 has a top end 16A positioned at such a level as to allow contact with the discharge surface 9 of the liquid discharge head 4 as placed in the discharge surface cleaning position.

The liquid receiving tray 2 is reciprocated rectilinearly in horizontal directions (leftward and rightward in FIG. 1) with respect to the discharge surface 9 by the wiping member moving mechanism 3, so that the wiping member 16 is also reciprocated rectilinearly in the horizontal directions with respect to the discharge surface 9.

The wiping member moving mechanism 3 has, for example, a rack formed on a lower surface of the liquid receiving tray 2, a pinion for engagement with the rack, and a motor 51 for rotating the pinion.

The wiping member 16 is formed as a thin sheet with a thickness of approximately 1 mm and a width equal to or greater than length of a liquid discharge nozzle row 13. Also, the wiping member 16 is formed of a material such as rubber. When brought into contact with the discharge surface 9, the wiping member 16 is pressed against the discharge surface 9 at a predetermined pressure and becomes bent.

The washing liquid application port 5 applies a washing liquid directly to the wiping member 16 on the path of its rectilinear reciprocating motion. The washing liquid application port 5 is connected to a washing liquid tank containing the washing liquid, through an electromagnetic valve 53. Pressurizing the washing liquid tank with a pressurizer 52 and turning on (opening) the electromagnetic valve 53 causes the washing liquid application port 5 to apply the washing liquid.

The absorbing members 6A, 6B are formed of a flexible porous resin (porous body). The absorbing members 6A, 6B are positioned at two respective ends of the path of the rectilinear reciprocating motion of the wiping member 16. When a wiping member washing process in which the wiping member is washed is performed, the absorbing members 6A, 6B absorb ink, and the washing liquid, on the wiping member 16.

The suction ports 7A, 7B has their ends respectively embedded in the absorbing members 6A, 6B from surfaces of the absorbing members 6A, 6B opposite to contact surfaces thereof with the wiping member 16. The suction ports 7A, 7B suck thereinto a liquid including ink and the like absorbed in the absorbing members 6A, 6B, respectively. The suction ports 7A, 7B are connected to a liquid waste tank through an electromagnetic valve 56. Applying negative pressure to the liquid waste tank by a depressurizer 55 and turning on (opening) the electromagnetic valve 56 causes the suction ports 7A, 7B to suck the liquid thereinto.

The absorbing members 6A, 6B are supported on supporting members 10A, 10B, respectively. The supporting members 10A, 10B are supported on fixing members 11A, 11B, respectively. The supporting member 10A, 10B are respectively combined with the fixing members 11A, 11B to be shaped into gates.

Thus, any drop of liquid that falls from the absorbing members 6A, 6B is received by the liquid receiving tray 2. The liquid receiving tray 2 is formed to be of such size that part of the liquid receiving tray 2 is always located immediately below the absorbing members 6A, 6B even when moved leftward and rightward by the wiping member moving mechanism 3. This prevents contamination of the device caused by dripping of liquid such as ink. It is to be noted that the absorbing members 6A, 6B are desirably supported by the supporting members 10A, 10B, respectively, at top portions thereof beyond the reach of the liquid absorbed in the absorbing members 6A, 6B.

The suction port 8 of the liquid receiving tray 2 has an open end in the bottom of the liquid receiving tray 2. The suction port 8 is connected to the liquid waste tank through an electromagnetic valve 57. Applying negative pressure to the liquid waste tank by the depressurizer 55 and turning on (opening) the electromagnetic valve 57 causes the suction port 8 to suck thereinto the liquid such as ink. The bottom of the liquid receiving tray 2 is slightly inclined toward the suction port 8 so that the drops of liquid are brought together in the suction port 8.

As well as the motor 51, the pressurizer 52, the electromagnetic valve 53, the depressurizer 55, and the electromagnetic valves 56, 57, a timer 54 is connected to the control section 50. The timer 54 measures elapsed time. The control section 50 has overall control of the motor 51, the pressurizer 52, the electromagnetic valve 53, the depressurizer 55, the electromagnetic valves 56, 57, and so on.

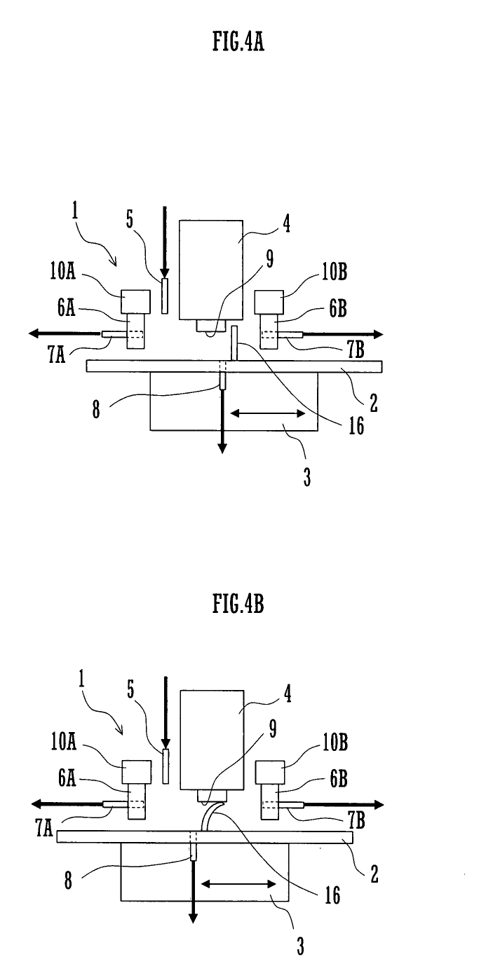

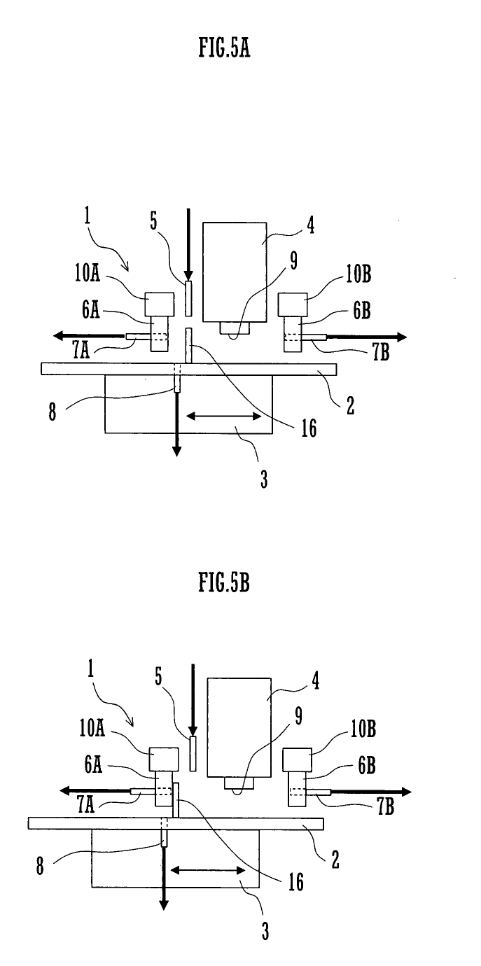

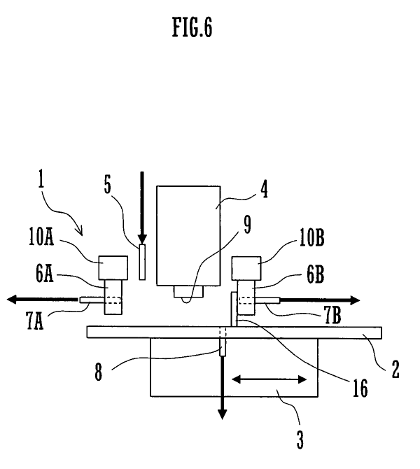

FIG. 4 is an explanatory drawing illustrating a discharge surface cleaning process performed by the discharge surface cleaning device 1. FIGS. 5 and 6 are explanatory drawings illustrating a wiping member washing process performed by the discharge surface cleaning device 1. In the present embodiment, the discharge surface cleaning device 1 performs a wiping member washing process each time the discharge surface cleaning device 1 performs a discharge surface cleaning process.

At the start of a discharge surface cleaning process, referring to FIG. 4A, the control section 50 places the liquid discharge head 4 to the discharge surface cleaning position, and the wiping member 16 to a discharge surface cleaning start position opposite the washing liquid application port 5 with respect to the discharge surface 9.

Then, referring to FIG. 4B, the control section 50 moves the wiping member 16 leftward in FIG. 4B and parallel to the discharge surface 9 by the wiping member moving mechanism 3, so that the wiping member 16 moves while remaining bent and in contact with the discharge surface 9. Thus, ink on the discharge surface 9 is wiped away by the wiping member 16, so that the discharge surface 9 is cleaned.

In advance of the discharge surface cleaning process, the discharge surface 9 is desirably made wet with ink discharged forcibly from the liquid discharge nozzle row 13. This reduces frictional resistance between the discharge surface 9 and the wiping member 16. In the present embodiment, ink is forcibly discharged from the liquid discharge nozzle row 13 by pressurizing an ink supply port connected to the liquid discharge head 4. The ink can be forcibly discharged from the liquid discharge nozzle row 13 by suction of the ink by applying negative pressure to the discharge surface 9.

After the discharge surface 9 is cleaned, referring to FIG. 5A, the control section 50 stops the wiping member 16 immediately below the washing liquid discharge port 5. Then, the control section 50 causes the washing liquid application port 5 to discharge the washing liquid directly to the wiping member 16, thereby washing the wiping member 16. Thus, most of the ink attached to the wiping member in the discharge surface cleaning process is washed away with the washing liquid. As described earlier, the control section 50 causes the washing liquid application port 5 to apply the washing liquid to the wiping member 16 by pressurizing the washing liquid tank and opening the electromagnetic valve 53. The applied washing liquid is received by the liquid receiving tray 2 and drained through the suction port 8.

After the discharge surface cleaning process is completed, alternatively, the wiping member 16 may be stopped at a left-side-surface application position where the washing liquid is applied to a left side surface of the wiping member 16 as in FIG. 5A, and at a right-side-surface application position where the washing liquid is applied to a right side surface of the wiping member 16, and the washing liquid may be applied to the wiping member 16 at each of the positions. This enhances effectiveness of removal of ink from the wiping member 16.

After the discharge surface cleaning process is completed, alternatively, the washing liquid may be applied to the wiping member 16 being moved, without stopping the wiping member 16 immediately below the washing liquid discharge port 5, by causing the washing liquid discharge port 5 to discharge the washing liquid in timing with the movement of the wiping member 16. This enhances the effectiveness of removal of ink from the wiping member 16 and, at the same time, allows quick washing of the wiping member 16.

Referring to FIG. 5B, the control section 50 further moves the wiping member 16 with the washing liquid applied thereto, and stops the wiping member 16 at a position where the left side surface of the wiping member 16 is pressed against the absorbing member 6A at a predetermined pressure. The contact of the wiping member 16 with the absorbing member 6A allows most of the ink on the left side surface of the wiping member 16 to be absorbed in the absorbing member 6A.

By opening the electromagnetic valve 56 with the wiping member 16 in contact with the absorbing member 6A, the control section 50 causes the liquid such as ink absorbed in the absorbing member 6A to be sucked through the suction port 7A, and the liquid such as ink on the left side surface of the wiping member 16 to be sucked through the absorbing member 6A. At this time, the negative pressure in the absorbing member 6A allows the liquid such as ink on the left side surface of the wiping member 16 to be effectively absorbed in the absorbing member 6A, so that there is little liquid left on the left side surface of the wiping member 16.

After the left side surface of the wiping member 16 is washed, referring now to FIG. 6, the control section 50 moves the wiping member 16 rightward in FIG. 6. Then, the control section 50 stops the wiping member 16 at a position where the right side surface of the wiping member 16 is pressed against the absorbing member 6B at a predetermined pressure. The contact of the wiping member 16 with the absorbing member 6B allows most of the ink on the right side surface of the wiping member 16 to be absorbed in the absorbing member 6B.

By opening the electromagnetic valve 56 with the wiping member 16 in contact with the absorbing member 6B, the control section 50 causes the liquid such as ink absorbed in the absorbing member 6B to be sucked through the suction port 7B, and the liquid such as ink on the right side surface of the wiping member 16 to be sucked through the absorbing member 6B.

Alternatively, the suction ports 7A and 7B may be operated independently by provision of a separate electromagnetic valve for each of the suction ports 7A and 7B.

The wiping member washing process is desirably performed at regular intervals, instead of only when the discharge surface cleaning process is performed. Most of the ink on the wiping member 16 and the absorbing members 6A, 6B is removed by the wiping member washing process. In a case where a small amount of ink remaining on the wiping member 16 and the absorbing members 6A, 6B is left unremoved for a long period of time and becomes solidified, however, the solidified ink on the wiping member 16 is rubbed against the discharge surface 9 when a next discharge surface cleaning process is performed. The solidified ink rubbed against the discharge surface 9 may cause damage to the discharge surface 9 such as scratches thereon.

That is the reason why the wiping member washing process is desirably performed at regular intervals, as described above. Performing the wiping member washing process at regular intervals ensures that the wiping member 16 is washed at regular intervals and ink, and the washing liquid, on the wiping member 16 is removed at regular intervals. This prevents damage to the discharge surface 9.

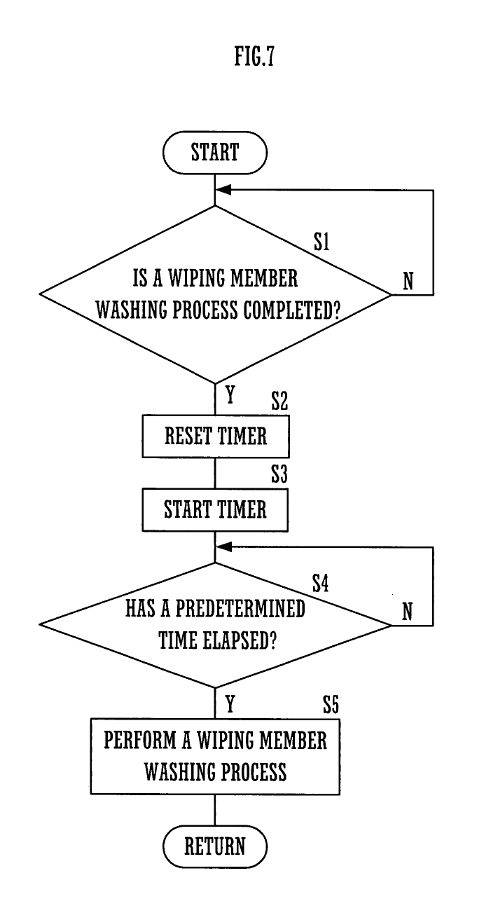

FIG. 7 is a flowchart illustrating part of steps performed by the control section 50. When the wiping member washing process is completed (step S1), the control section 50 resets the timer 54 (step S2), and then starts the timer 54 (step S3). When judging based on time measurement data input from the timer 54 that a predetermined time has elapsed since a previous wiping member washing process (step S4), the control section 50 performs a wiping member washing process (step S5).

The predetermined time as in step S4 is set to a shorter time than a time that it takes for ink to become solidified. In a case in which a discharge surface cleaning process is performed while the timer 54 is measuring time, the control section 50 proceeds to step S1 after a wiping member washing process subsequent to the discharge surface cleaning process is completed. This ensures that the wiping member washing process is performed properly at regular intervals.

As described above, the wiping member washing process performed at regular intervals prevents solidification of any small amount of ink remaining on the wiping member 16 and the absorbing members 6A, 6B. This prevents damage to the discharge surface 9, and deterioration of the absorbing members 6A, 6B, caused by solidified ink being rubbed against the discharge surface 9, and ensures for a long period of time that the discharge surface 9 is cleaned.

The discharge surface cleaning device 1 enables ink on the wiping member 16 to be washed away by direct application of the washing liquid to the wiping member 16. This enhances effect of prevention of contamination of the wiping member 16, thereby improving the effectiveness of removal of ink from the discharge surface 9 of the liquid discharge head 4. This improves precision of ink discharge of the liquid discharge head 4.

Also, the provision of the suction ports 7A, 7B in the discharge surface cleaning device 1 allows ink and the washing liquid absorbed in the absorbing members 6A, 6B to be effectively removed from the wiping member 16 through the suction of the ink and the washing liquid by the suction ports 7A, 7B when the wiping member 16 is brought into contact with the absorbing members 6A, 6B. Also, the discharge surface cleaning device 1 prevents a reduction in absorbability of the absorbing members 6A, 6B, and therefore enhances the effect of prevention of contamination of the wiping member 16. Moreover, the discharge surface cleaning device 1 enables a reduced frequency of replacement of the absorbing members 6A, 6B.

Further, the wiping member moving mechanism 3 used for moving the wiping member 16 relative to the discharge surface 9 can be also used as a moving mechanism for applying the washing liquid to the wiping member 16. This results in downsizing and low manufacturing cost of the discharge surface cleaning device 1.

Furthermore, the absorbing members 6A, 6B positioned at the two respective ends of the path of the rectilinear reciprocating motion of the wiping member 16 allow the ink and the washing liquid on the wiping member 16 to be removed from the two side surfaces thereof, thereby further enhancing the effect of prevention of contamination of the wiping member 16.

Also, the flexible porous resin used as the absorbing members 6A, 6B allows the ink and the like to be removed from the wiping member 16 without damaging the wiping member 16 when brought into contact with the wiping member 16.

Moreover, the effect of prevention of contamination of the wiping member 16 is further enhanced by the wiping member washing process to remove the ink and the like from the wiping member 16 being performed each time the discharge surface cleaning process, which involves attachment of ink to the wiping member, is performed.

Further, performing the wiping member washing process at regular intervals prevents the ink attached to the wiping member 16 and absorbed in the absorbing members 6A, 6B from becoming solidified. The prevention of solidification of the ink on the wiping member 16 results in prevention of damage to the discharge surface 9. The prevention of solidification of the ink absorbed in the absorbing members 6A, 6B results in prevention of a reduction in absorbability of the absorbing members 6A, 6B, and therefore further enhances the effect of prevention of contamination of the wiping member 16. The prevention of solidification of the ink absorbed in the absorbing members 6A, 6B also results in prevention of attachment of the solidified ink to the wiping member 16.

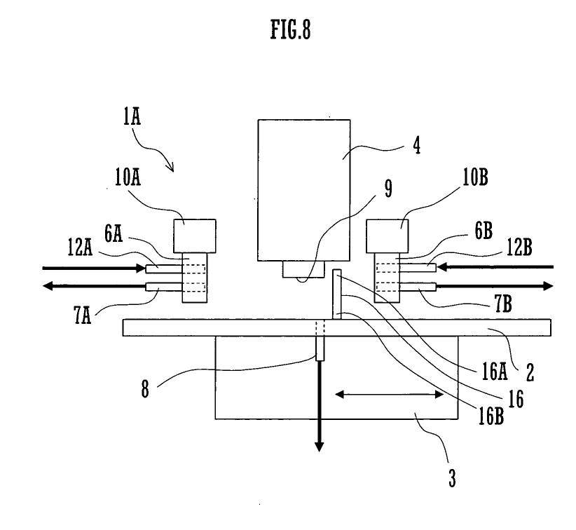

FIG. 8 is a front view illustrating a schematic configuration of a discharge surface cleaning device 1A according to another embodiment of the invention. The discharge surface cleaning device 1A is similar in configuration to the discharge surface cleaning device 1, except for washing liquid discharge ports 12A, 12B provided instead of the washing liquid discharge port 5. In the present embodiment, the washing liquid discharge ports 12A, 12B correspond to the washing liquid discharge device of the invention.

In the discharge surface cleaning device 1A, the washing liquid discharge port 12A and the suction port 7A has their respective ends embedded in the absorbing member 6A. Similarly, the washing liquid discharge port 12B and the suction port 7B have their respective ends embedded in the absorbing member 6B.

The washing liquid discharge ports 12A, 12B are connected to a washing liquid tank containing a washing liquid, through the electromagnetic valve 53. Pressurizing the washing liquid tank with a pressurizer and turning on (opening) the electromagnetic valve 53 causes the washing liquid discharge ports 12A, 12B to apply the washing liquid. In the present embodiment, the washing liquid discharge ports 12A, 12B correspond to the washing liquid discharge device of the invention.

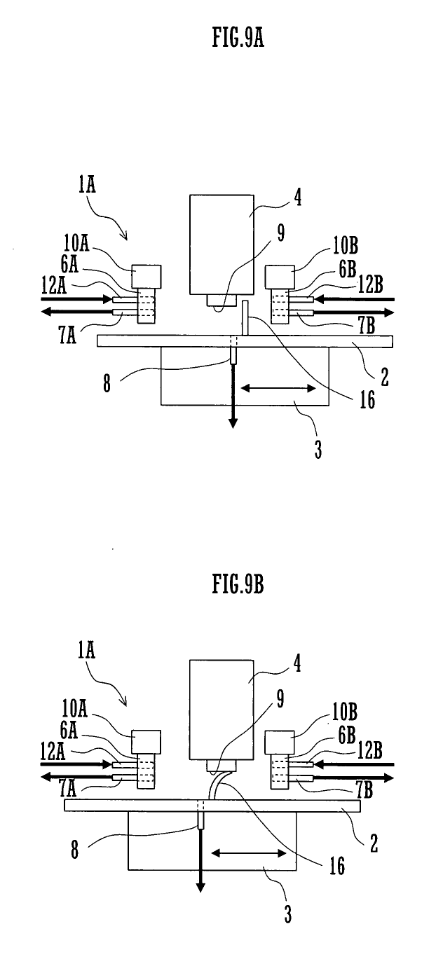

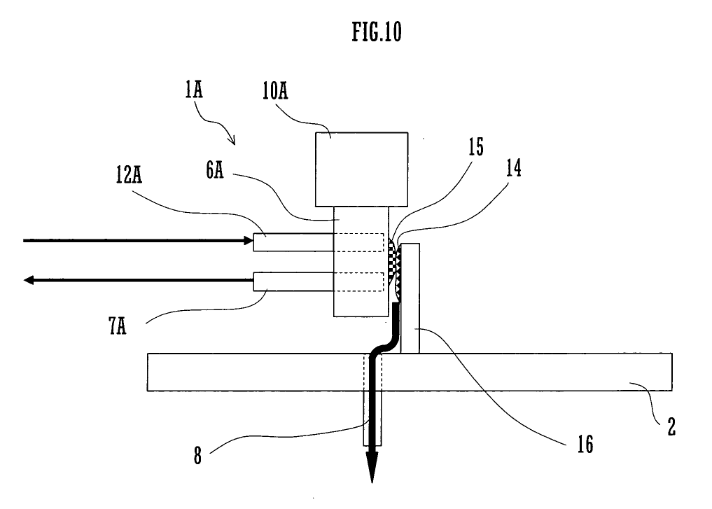

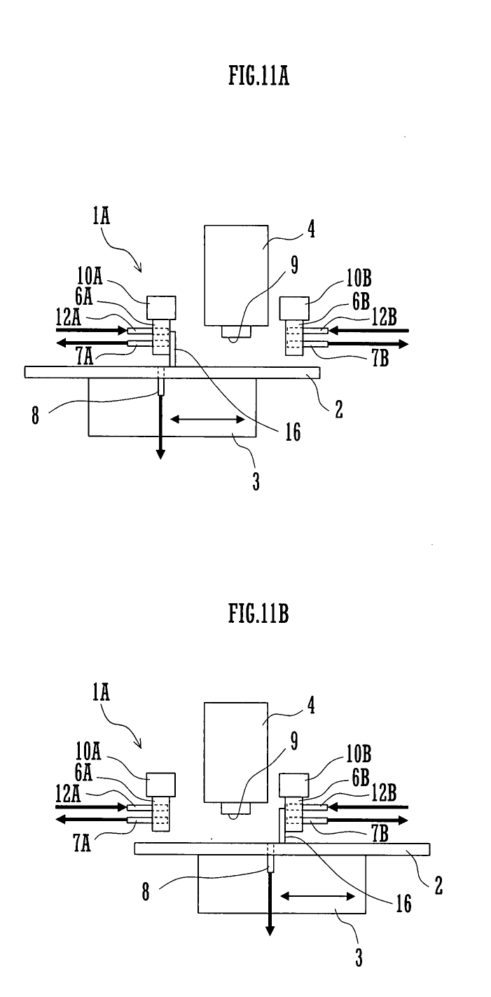

FIG. 9 is an explanatory drawing illustrating a discharge surface cleaning process performed by the discharge surface cleaning device 1A. FIG. 10 is an explanatory drawing illustrating a wiping member pre-washing process performed by the discharge surface cleaning device 1A. FIG. 11 is an explanatory drawing illustrating the wiping member washing process performed by the discharge surface cleaning device 1A.

First, the discharge surface cleaning process will be described below. At the start of the discharge surface cleaning process, referring to FIG. 9A, the control section 50 places the liquid discharge head 4 to the discharge surface cleaning position. Then, referring to FIG. 9B, the control section 50 moves the wiping member 16 in a direction parallel to the discharge surface 9 (rightward in FIG. 9B in the present embodiment) by the wiping member moving mechanism 3, so that the wiping member 16 moves while remaining bent and in contact with the discharge surface 9. Thus, ink on the discharge surface 9 is wiped away by the wiping member 16, so that the discharge surface 9 is cleaned.

Next, the wiping member pre-washing process will be described below. After the discharge surface 9 is cleaned, referring to FIG. 10, the control section 50 further moves the wiping member 16, and stops the wiping member 16 at a position where the left side surface of the wiping member 16 is almost brought into contact with the absorbing member 6A.

With a gap thus formed between the left side surface of the wiping member 16 and the absorbing member 6A, the control section 50 causes the washing liquid discharge port 12A to discharge the washing liquid. Thus, the washing liquid seeps through the absorbing member 6A and is applied to the left side surface of the wiping member 16, to wash the left side surface of the wiping member 16. Then, the washing liquid drops through the gap between the left side surface of the wiping member 16 and the absorbing member 6A. The drops of washing liquid are received by the liquid receiving tray 2 and drained through the suction port 8.

The washing liquid discharged from the washing liquid discharge port 12A and absorbed in the absorbing member 6A, and the ink and the washing liquid absorbed in the absorbing member 6A while dropping, are sucked through the suction port 7A.

The ink on the wiping member 16 is removed more effectively by performing the wiping member pre-washing process in which, after the washing liquid is applied to the wiping member 16 with the gap formed between the wiping member 16 and the absorbing member 6A, the liquid such as the washing liquid absorbed in the absorbing member 6A is sucked through the suction port 7A.

The above-mentioned gap between the wiping member 16 and the absorbing member 6A is of such size that the wiping member 16 faces the absorbing member 6A across ink 14 on the wiping member 16 and washing liquid 15 discharged from the washing liquid discharge port 12A and seeped through the absorbing member 6A.

Finally, the wiping member washing process will be described below. After the wiping member pre-washing process, referring to FIG. 11A, the control section 50 moves the wiping member 16 further leftward, and stops the wiping member 16 at a position where the left side surface of the wiping member 16 is pressed against the absorbing member 6A at a predetermined pressure. The contact of the wiping member 16 with the absorbing member 6A allows most of the ink on the left side surface of the wiping member 16 to be absorbed in the absorbing member 6A.

With the wiping member 16 in contact with the absorbing member 6A, the control section 50 causes the washing liquid discharge port 12A to discharge the washing liquid. Thus, the washing liquid seeps through the absorbing member 6A and is applied to the left side surface of the wiping member 16, to wash the left side surface of the wiping member 16.

Part of the washing liquid with which the left side surface of the wiping member 16 has been washed, and part of the ink washed away from the left side surface of the wiping member 16, are absorbed in the absorbing member 6A, and the rest of the liquids are received by the liquid receiving tray 2 and drained through the suction port 8.

After the washing liquid is applied, the control section 50 causes the ink and the washing liquid absorbed in the absorbing member 6A to be sucked through the suction port 7A, and the ink and the washing liquid on the left side surface of the wiping member 16 to be sucked through the absorbing member 6A.

After the left side surface of the wiping member 16 is washed as described above, the control section 50 moves the wiping member 16 rightward in FIG. 11A. Then, the control section 50 performs a wiping member pre-washing process on the right side surface of the wiping member 16 in a similar manner to that as described with reference to FIG. 10.

After completing the wiping member pre-washing process on the right side surface of the wiping member 16, referring to FIG. 11B, the control section 50 moves the wiping member 16 further rightward in FIG. 11B, and stops the wiping member 16 at a position where the right side surface of the wiping member 16 is pressed against the absorbing member 6B at a predetermined pressure. The contact of the wiping member 16 with the absorbing member 6B allows most of the ink on the right side surface of the wiping member 16 to be absorbed in the absorbing member 6B.

With the wiping member 16 in contact with the absorbing member 6B, the control section 50 causes the washing liquid discharge port 12B to discharge the washing liquid. Thus, the washing liquid seeps through the absorbing member 6B and is applied to the right side surface of the wiping member 16, to wash the left side surface of the wiping member 16. After the washing liquid is applied, the control section 5G causes the ink and the washing liquid absorbed in the absorbing member 6B to be sucked through the suction port 7B, and the ink and the washing liquid on the left side surface of the wiping member 16 to be sucked through the absorbing member 6B.

The discharge surface cleaning device 1A eliminates the need for a process, such as performed in the discharge surface cleaning device 1, to wash the wiping member 16 immediately below the washing liquid discharge port 5, and at the same time, saves space for the washing liquid discharge port 5.

Also, the discharge surface cleaning device 1A enables the absorbing members 6A, 6B, as well as the wiping member 16, to be washed with the washing liquid.

Further, the wiping member pre-washing process as described with reference to FIG. 10 further enhances the effect of prevention of contamination of the wiping member.

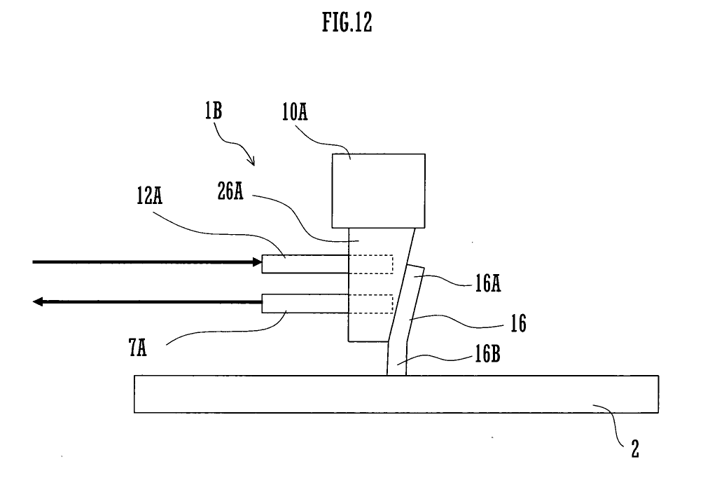

FIG. 12 is an enlarged view illustrating a configuration of part of a discharge surface cleaning device 1B according to still another embodiment of the invention.

The discharge surface cleaning device 1B is similar in configuration to the discharge surface cleaning device 1A, except for absorbing members 26A, 26B (the absorbing member 26B is not shown) provided instead of the absorbing members 6A, 6B, respectively.

In the discharge surface cleaning device 1B, each of the absorbing members 26A, 26B has an inclined surface on a side for contact with the wiping member 16. The inclined surfaces are inclined toward a direction to come into contact with the top end 16A of the wiping member 16, before the bottom end 16B, when brought into contact with the wiping member 16.

The discharge surface cleaning device 1B causes the absorbing members 26A, 26B to be pressed against the top end 16A at a higher contact pressure than against the bottom end 16B. This enhances effectiveness of removal of ink from the top end 16A that has attached thereto a larger amount of ink removed from the discharge surface 9. The enhanced effectiveness results in an improvement in effectiveness of ink removal from the discharge surface 9 by the wiping member 16.

The discharge surface cleaning device 1B enables the absorbing members 26A, 26B to follow the shape of the wiping member 16, even when the shape changes with time as the wiping member 16 becomes bent while being pressed against the discharge surface 9, and the wiping member 16 becomes warped at last. This allows closer contact between the wiping member 16 and the absorbing members 26A, 26B and therefore ensures that ink on the wiping member is absorbed by the absorbing members 26A, 26B.

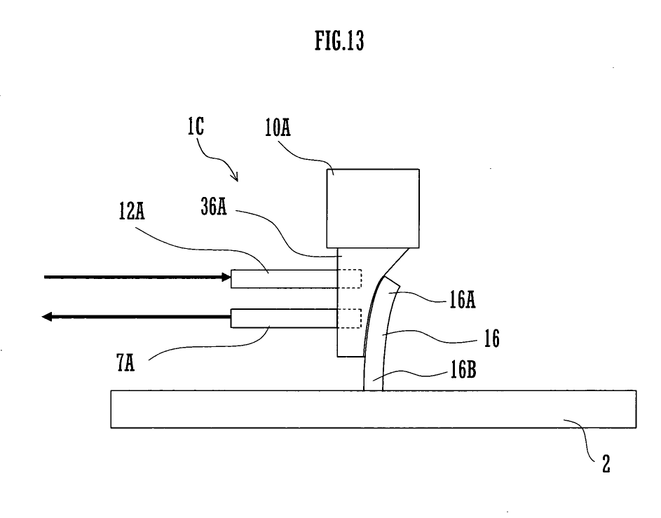

Referring to FIG. 13, a discharge surface cleaning device 1C according to yet another embodiment of the invention is provided with absorbing members 36A, 36B (the absorbing member 36B is not shown) instead of the absorbing members 6A, 6B, respectively, provided in the discharge surface cleaning device 1A.

In the discharge surface cleaning device 1C, each of the absorbing members 36A, 36B has a curved surface on a side for contact with the wiping member 16. The curved surfaces are curved toward a direction to come into contact with the top end 16A of the wiping member 16, before the bottom end 16B, when brought into contact with the wiping member 16. The discharge surface cleaning device 1C has advantages similar to those of the discharge surface cleaning device 1B.

Alternatively, the absorbing members 26A, 26B, or the absorbing members 36A, 36B, may be used in the discharge surface cleaning device 1.

In the foregoing embodiments, the liquid discharge head 4 is stopped, and the wiping member 16 is moved, when the discharge surface cleaning process and the wiping member washing process are performed. However, the combination of movements of the component elements includes, but is not limited to, what is described above. For example, the wiping member 16 may be held still, and the liquid discharge head 4 may be reciprocated rectilinearly. When this is applied to the discharge surface cleaning device 1, the washing liquid discharge port 5, the absorbing members 6A, 6B, and the suction ports 7A, 7B are moved with the liquid discharge head 4. When this is applied to the discharge surface cleaning device 1A as well as the discharge surface cleaning devices 1B and 1C, the absorbing members 6A, 6B, the suction ports 7A, 7B, and the washing liquid discharge ports 12A, 12B are moved with the liquid discharge head 4.

The invention is applicable to: printers provided with the liquid discharge head 4; manufacturing machines for use in the manufacture of semiconductors and liquid crystal panels; and the like.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A discharge surface cleaning device for a liquid discharge head, comprising:
a wiping member for cleaning a discharge surface of the liquid discharge head that discharges ink, by moving relative to the discharge surface while in contact with the discharge surface;
a washing liquid discharge device for applying a washing liquid directly to the wiping member; and
one or more absorbing members for absorbing ink, and the washing liquid, on the wiping member.

2. The discharge surface cleaning device for a liquid discharge head according to claim 1, wherein:
the wiping member reciprocates rectilinearly parallel to and relative to the discharge surface, and
the washing liquid discharge device applies the washing liquid to the wiping member on a path of the rectilinear reciprocating motion of the wiping member.

3. The discharge surface cleaning device for a liquid discharge head according to claim 1, wherein:
the wiping member reciprocates rectilinearly parallel to and relative to the discharge surface, and
the absorbing members are positioned at two respective ends of the path of the rectilinear reciprocating motion of the wiping member.

4. The discharge surface cleaning device for a liquid discharge head according to claim 1, further comprising a suction device for sucking ink, and the washing liquid, absorbed in the absorbing members.

5. A discharge surface cleaning device for a liquid discharge head, comprising:
a wiping member for cleaning a discharge surface of the liquid discharge head that discharges ink, by moving relative to the discharge surface while in contact with the discharge surface;
one or more absorbing members for absorbing a liquid including ink on the wiping member when brought into contact with the wiping member;
a washing liquid discharge device for applying a washing liquid to the wiping member through the absorbing members; and
a suction device for sucking the liquid including ink absorbed in the absorbing members.

6. The discharge surface cleaning device for a liquid discharge head according to claim 5, wherein the washing liquid discharge device applies the washing liquid to the wiping member in a state in which there is a gap for the liquid including ink on the wiping member to drop through formed between the wiping member and each of the absorbing members.

7. The discharge surface cleaning device for a liquid discharge head according to claim 5, wherein:
the wiping member reciprocates rectilinearly parallel to and relative to the discharge surface, and
the absorbing members are positioned at two respective ends of the path of the rectilinear reciprocating motion of the wiping member.

8. The discharge surface cleaning device for a liquid discharge head according to claim 3 or 7, wherein each of the absorbing members includes a flexible porous body.

9. The discharge surface cleaning device for a liquid discharge head according to claim 3 or 7, wherein:
the wiping member has a top end for contact with the discharge surface and a bottom end fixed at a predetermined position, and
each of the absorbing members has an inclined or curved surface that is to come into contact with the top end of the wiping member, before the bottom end, when the absorbing members are brought into contact with the wiping member.

10. The discharge surface cleaning device for a liquid discharge head according to claim 1 or 5, further comprising:
a timer for measuring time elapsed since the washing liquid discharge device has previously applied the washing liquid to the wiping member; and
a control section for causing the washing liquid discharge device to apply the washing liquid to the wiping member when the control section judges based on measurement result of the timer that a predetermined time has elapsed since the washing liquid discharge device has previously applied the washing liquid to the wiping member.

11. The discharge surface cleaning device for a liquid discharge head according to claim 1 or 5, wherein, each time the wiping member cleans the discharge surface, the washing liquid discharge device applies the washing liquid to the wiping member, and the absorbing members absorb ink, and the washing liquid, on the wiping member.
